(19) United States
(12) Patent Application Publication
(10) Pub. No.: US 2024/0144952 A1
(43) Pub. Date: May 2, 2024

(54) SOUND SOURCE SEPARATION APPARATUS, SOUND SOURCE SEPARATION METHOD, AND PROGRAM

(71) Applicant: NIPPON TELEGRAPH AND TELEPHONE CORPORATION, Tokyo (JP)

(72) Inventors: Rintaro IKESHITA, Tokyo (JP); Nobutaka ITO, Tokyo (JP); Tomohiro NAKATANI, Tokyo (JP)

(73) Assignee: NIPPON TELEGRAPH AND TELEPHONE CORPORATION, Tokyo (JP)

(21) Appl. No.: 18/277,065

(22) PCT Filed: Feb. 15, 2021
(86) PCT No.: PCT/JP2021/005483

§ 371 Date: Aug. 12, 2023

(51) Int. Cl. G10L 21/0308; G10L 21/0208

(52) U.S. Cl. CPC G10L 21/0308; G10L 21/0208

(57) ABSTRACT

A sound source signal is estimated with high accuracy in a noise environment. A sound source signal estimation unit (15) estimates each sound source signal using a separation matrix from an observation signal obtained by collecting a mixed acoustic signal in which a plurality of sound source signals and diffusive noise are mixed by a microphone array formed by a plurality of microphones The separation matrix is configured to convert steering vectors from each sound source to the microphone into unit vectors and convert a spatial covariance matrix of the diffusive noise into a matrix including a diagonal matrix with a size of the number of sound sources.

### TECHNICAL FIELD

The present invention relates to a sound source separation technology for estimating a source signal of each sound source from an observation signal under a noise environment.

### BACKGROUND ART

A sound source separation technology for estimating a source signal of each sound source by accepting an observed mixed acoustic signal as an input under a noise environment is a technology widely used for preprocessing or the like of speech recognition. Independent low-rank matrix analysis (ILRMA) is known as a scheme of performing sound source separation using a plurality of microphones (see NPL 1).

### CITATION LIST

### Non Patent Literature

[NPL 1] Daichi Kitamura, Nobutaka Ono, Hiroshi Sawada, Hirokazu Kameoka, and Hiroshi Saruwatari, “Determined blind source separation unifying independent vector analysis and nonnegative matrix factorization,” IEEE/ACM Transactions on Audio, Speech, and Language Processing, vol. 24, No. 9, PP. 1626 to 1641, 2016.

### SUMMARY OF INVENTION

### Technical Problem

It is known that noise is not taken into consideration in a probability model in ILRMA described in NPL 1. Therefore, separation performance of ILRMA deteriorates in a noise environment.

In view of the above technical problems, an objective of the present invention is to provide a sound source separation technology capable of estimating a sound source signal with high accuracy in a noise environment.

### Solution to Problem

According to an aspect of the present invention, a sound source separation device includes a sound source signal estimation unit configured to estimate each sound source signal using a separation matrix from an observation signal obtained by collecting a mixed acoustic signal in which a plurality of sound source signals and diffusive noise are mixed by a microphone array formed by a plurality of microphones. The separation matrix is configured to convert steering vectors from each sound source to the microphone into unit vectors, and convert a spatial covariance matrix of the diffusive noise into a matrix including a diagonal matrix with a size of the number of sound sources.

### Advantageous Effects of Invention

According to the present invention, a sound source signal can be estimated with high accuracy in a noise environment.

### BRIEF DESCRIPTION OF DRAWINGS

FIG. 1 is a diagram illustrating a functional configuration of a sound source separation device.

FIG. 2 is a diagram illustrating a processing procedure of a sound source separation method.

FIG. 3 is a diagram illustrating an experiment result by the sound source separation device an according to an embodiment.

FIG. 4 is a diagram illustrating a functional configuration of a computer.

### DESCRIPTION OF EMBODIMENTS

Hereinafter, embodiments of the present invention will be described in detail. The same reference numbers are given to constituent units that have the same functions in the drawings and repeated description thereof will be omitted.

### <Definition of Symbols>

O_{α, β} represents a zero matrix of α×β. I_{α} represents a unit matrix of α×α. S^{α}₊ and S^{α}₊₊ respectively represent the sets of all semi-positive value or positive value Hermitian matrices with a size α. GL(α) represents the set of all regular matrices on a complex number field with size α×α. R_{≥0} represents the set of all non-negative real numbers. e_{α} is a unit vector in which an α-th element is 1 and the other elements are 0.

### <Sound Source Separation Problem in Diffusive Noise Environment>

The present invention deals with a blind source separation (BSS) problem of a multi-channel blind sound source in an environment in which there is non-stationary diffusive noise. Since the diffusive noise (hereinafter simply referred to as “noise”) is a sum of signals arriving in various directions, it cannot be sufficiently inhibited only by directivity control in which a linear time-invariant separation filter such as beam forming or independent component analysis (ICA) is used.

As schemes of modeling spatial correlation of noise and non-constancy of a spectrum accurately, full rank covariance analysis (FCA), multi-channel non-negative matrix factorization (MNMF), and the like have been studied. However, in these known schemes, it is necessary to solve an estimation problem of a mixed model of an observation signal. Therefore, there are problems that convergence of optimization is late and separation performance strongly depends on initial values of parameters. In recent years, FastFCA and FastMNMF for approximation acceleration of FCA and MNMF have been proposed, but the problem of the dependence of initial values of optimization has not yet been solved.

As a scheme of solving the BSS problem using a separation model, independent vector analysis (IVA), independent low-rank matrix analysis (ILRMA), rank-constrained FastMNMF, and the like have been studied. IVA and ILRMA are BSS schemes that operate stably and at high speeds, but are problematic in that noise is not modeled. In rank-constrained FastMNMF, the problem of dependency of initial values of optimization has not yet been solved as in FastMNMF. In addition, NoisylCA in which an algorithm of ICA is extended with respect to a noise environment has been studied. However, problems still remain in that noise is assumed to be a stationary Gaussian, and only sound source separation can be executed by a linear time-invariant filter.

In the present specification, an observation signal x from a microphone array formed by M microphones is assumed to be a sum of a linear mixture of K sound source signals s₁, . . . , s_{K} and diffusive noise n. A sound source separation problem in a diffusive noise environment is defined as follows.

$$\begin{matrix}[ Math . 1 ] & \\ x ( f , t ) = {{\sum }_{i = 1}}^{K} {x}_{i} ( f , t ) + n ( f , t ) ∈ {ℂ}^{M} & ( 1 )\end{matrix}$$

$${x}_{i} ( f , t ) = {a}_{i} ( f ) {s}_{i} ( f , t ) ∈ {ℂ}^{M} \qquad ( 2 )$$

$${a}_{i} ( f ) ∈ {ℂ}^{M} , {s}_{i} ( f , t ) ∈ ℂ , i ∈ \{ 1 , ⋯ , K \} \qquad ( 3 )$$

Here, f=1, . . . , F is an index of a frequency bin, and t=1, . . . , T is an index of a time frame. aᵢ represents a transfer function (a steering vector) from a sound source i to each microphone.

In the present specification, a problem of estimating the sound images x₁, . . . , x_{K} of respective sound sources from only the observation signal x is handled. Hereinafter, 1≤K≤M is assumed.

### <Accidental Diagonalization Constraint>

The present invention provides a BSS scheme in which a probability model is equivalent to rank-constrained FastMNMF and MNMF is imposed with an accidental diagonalization constraint of Definition 1. Hereinafter, the BSS scheme according to the present invention is also referred to as NoisyILRMA.

### «Definition 1: Accidental Diagonalization Constraint»

It is assumed that there are a certain regular matrix W(f)∈GL(M) and a diagonal matrix G(f)∈S^{K}₊₊ for K steering vectors a₁(f), . . . , a_{K}(f)∈C^{M} and a spatial covariance matrix Vₙ(f)∈S^{M}₊₊, of the diffusive noise and the following expression is satisfied. This assumption is referred to as an accidental diagonalization constraint.

$$\begin{matrix}[ Math . 2 ] & \\ {W ( f )}^{h} {a}_{i} ( f ) = {e}_{i} ∈ {ℂ}^{M} , i ∈ \{ 1 , ⋯ , K \} & ( 4 )\end{matrix}$$

$${W ( f )}^{h} V ( f ) W ( f ) = [ \begin{matrix}G ( f ) & {O}_{K , M - K} \\ {O}_{M - K , K} & {I}_{M - K}\end{matrix} ] ∈ {S}_{++}^{M}$$

In the following Proposition 1, the physical meaning of the accidental diagonalization constraint is clarified.

### «Proposition 1»

There are a regular matrix W∈GL(M) and a positive value matrix G∈S^{K}₊₊ for K (≤M) linear independent vectors A1=[a₁, . . . , a_{K}] of C^{M×K} and a positive value matrix V ∈S^{M}₊₊, and the following expression is satisfied.

$$\begin{matrix}[ Math . 3 ] & \\ {W}^{h} [ {a}_{1} , ⋯ , {a}_{K} ] = [ {e}_{1} , ⋯ , {e}_{K} ] ∈ {ℂ}^{M \times K} & ( 5 )\end{matrix}$$

$${W}^{h} VW = [ \begin{matrix}G & {O}_{K , M - K} \\ {O}_{M - K , K} & {I}_{M - K}\end{matrix} ] ∈ {S}_{++}^{M} \qquad ( 6 )$$

When W₁ is defined in the following expression,

[Math. 4]

W₁=[w₁, . . . , w_{K}]∈ [symbol] ^{M×K} 97)

Each of w₁, . . . , wₖ∈C^{M} and G∈S^{K}₊₊ is expressed by the following expression.

[Math. 5]

Wᵢ=V⁻¹A₁(A₁^{h}V⁻¹A₁)⁻¹eᵢ∈ [symbol] ^{M} (8)

G=W₁^{h}VW₁=(A₁^{h}V⁻¹A₁)⁻¹∈S₊₊^{K} (9)

By applying Proposition 1, it can be understood that variable conversion for parameters related to a spatial model of MNMF can be equivalently performed from (a₁, . . . , a_{K}, Vₙ) to (W, G). From Proposition 1, a relationship between NoisyILRMA (that is, MNMF on which the accidental diagonalization constraint is imposed) and MNMF can be said as follows.

(1) when K=1, NoisyILRMA is equivalent to MNMF.

(2) when K≥2, NoisyILRMA is equivalent to MNMF except that a non-diagonal component of G(f) is constrained to 0.

In particular, since variables w₁, . . . , w_{K} of NoisyILRMA satisfy Expression (8), it is important that it can be interpreted as a linear constraint minimum variance (LCMV) beamformer defined by the optimization problem shown in the following expression.

$$\begin{matrix}[ Math . 6 ] & \\ \begin{matrix}minimize {w}_{i}^{h} {Vw}_{i} \\ subject to {w}_{i}^{h} {A}_{1} = {e}_{i}^{T} ∈ {ℂ}^{1 \times K}\end{matrix} \} & ( 10 )\end{matrix}$$

### <Model Definition of NoisyILRMA>

The probability model of NoisyILRMA is equivalent to the probability model of rank-constrained FastMNMF and is defined as follows as a scheme of imposing an accidental diagonalization constraint of Definition 1 on MNMF.

[Math. 7]

W(f)=[w₁(f), . . . , w_{K}(f), Wₙ(f)] (11)

wᵢ(f)∈ [symbol] ^{M}, i=1, . . . , K (12)

Wₙ(f)∈ [symbol] ^{M×(M-K)} (13)

sᵢ(f, t)+nᵢ(f, t)=wᵢ(f)^{h}x(f, t)∈ [symbol] (14)

sᵢ(f, t)˜ [symbol] (0, λᵢ(f, t)) (15)

nᵢ(f, t)˜ [symbol] (0, λᵢ(f, t)) (16)

z(f, t)=Wₙ(f)^{h}x(f, t)∈ [symbol] ^{M-K} (17)

z(f, t)˜ [symbol] (0_{M-K}, λₙ(f, t)Ω(f)) (18)

λⱼ=ΦⱼΨⱼ∈ [symbol] _{≥0}^{F×T}, j∈{1, . . . , M, n} (19)

Φⱼ∈ [symbol] _{≥0}^{F×r}, Ψⱼ∈ [symbol] _{≥0}^{r×T} (20)

Ω(f)∈S₊₊^{M-K} (21)

Here, Expressions (19) and (20) are expressions by non-negative matrix factorization (NMF) of the power spectrum λᵢ, and r∈R_{≥0} is the base number of the NMF. Probability variables {sᵢ(f, t), nᵢ(f, t), z(f, t)}_{i,f,t} are independent.

The spatial covariance matrix Ω(f) ∈S^{M-K}₊₊ of the noise signal z can select the unit matrix I_{M-K}, and is introduced as a parameter to be estimated purposely in order to improve efficiency of an optimization algorithm to be described below.

A difference between the NoisyILRMA and the rank-constrained FastMNMF is that in the rank-constrained FastMNMF, nᵢ(f, t) in Expression (16) is defined as follows.

[Math. 8]

nᵢ(f, t)˜ [symbol] (0, gᵢ(f)λₙ(f, t) (16′)

NoisyILRMA is assumed to be normally gᵢ(f)=1 by performing the subsequent variable conversion in the probability model of the rank-constrained FastMNMF. Accordingly, NoisyILRMA and rank constrained FastMNMF are intrinsically equivalent.

$$\begin{matrix}[ Math . 9 ] & \\ {w}_{i} ( f ) ← {w}_{i} ( f ) {{g}_{i} ( f )}^{- \frac{1}{2}} & ( 22 )\end{matrix}$$

$${s}_{i} ( f , t ) ← {s}_{i} ( f , t ) {{g}_{i} ( f )}^{- \frac{1}{2}} \qquad ( 23 )$$

$${n}_{i} ( f , t ) ← {n}_{i} ( f , t ) {{g}_{i} ( f )}^{- \frac{1}{2}} \qquad ( 24 )$$

$${λ}_{i} ( f , t ) ← {λ}_{i} ( f , t ) {{g}_{i} ( f )}^{- 1} \qquad ( 25 )$$

Features of NoisyILRMA are expressed in Expression (14). That is, (1) the separation filter wᵢ extracts only a sound source i for a point sound source, (2) a signal separated by the separation filter wᵢ is modeled as a sum of the sound source signal sᵢ and the residual noise nᵢ. According to the feature (1), by optimizing the separation filter wᵢ, sound source separation (a point sound source can be separated and residual noise cannot be removed) can be achieved. According to the feature (2), not only the point sound source can be separated but residual noise can also be removed.

### <Optimization Algorithm>

Parameters W, Ω, Φ, Ψ of the NoisyILRMA can be optimized as follows based on the maximum likelihood method.

$$\begin{matrix}[ Math . 10 ] & \\ minimize g ( W , Ω , Φ , Ψ ) = - log p ( x ) & ( 26 )\end{matrix}$$

$$g ( W , Ω , Φ , Ψ ) = - log {\vert det W \vert}^{2} + log det Ω + \frac{1}{T} {\sum }_{i = 1}^{K} {\sum }_{t = 1}^{T} [ \frac{{\vert {{w}_{í} ( f )}^{h} x ( f , t ) \vert}^{2}}{{λ}_{i} ( f , t ) + {λ}_{n} ( f , t )} + log ( {λ}_{i} ( f , t ) + {λ}_{n} ( f , t ) ) ] + \frac{1}{T} {{\sum }^{T}}_{t = 1} [ \frac{{z ( f , t )}^{h} {Ω ( f )}^{- 1} z ( f , t )}{{λ}_{n} ( f , t )} + log {{λ}_{n} ( f , t )}^{M - K} ] \qquad ( 27 )$$

In the present invention, an algorithm for alternately optimizing the parameters (W, Ω) and the parameters (Φ, Ψ) is introduced. The optimization algorithm according to the present invention can optimize the parameters (W, Ω) faster than an algorithm derived for the rank-constrained FastMNMF by applying an iterative projection (IP) method developed for independent vector extraction (IVE). Further, by reducing the parameters {gᵢ(f)}_{i,f} of the rank-constrained FastMNMF, a simple optimization algorithm can be derived for the parameters (Φ,l Ψ).

### «Optimization Problem of Parameters (W, Ω)»

When the parameters (Φ, Ψ) are fixed, a problem of minimizing an objective function g with respect to the parameters (W, Ω) is written and expressed as follows.

$$\begin{matrix}[ Math . 11 ] & \\ {minimize}_{W , Ω} g ( W , Ω ) & ( 28 )\end{matrix}$$

$$g ( W , Ω ) {\sum }_{i = 1}^{K} {w}_{i}^{h} {R}_{i} {w}_{i} + tr ( {W}_{n}^{h} {R}_{n} {W}_{n} {Ω}^{- 1} ) - log {\vert det W \vert}^{2} + log det Ω \qquad ( 29 )$$

$${R}_{i} = \frac{1}{T} {\sum }_{t = 1}^{T} \frac{x ( f , t ) {x ( f , t )}^{h}}{{λ}_{i} ( f , t ) + {λ}_{n} ( f , t )} ∈ {S}_{++}^{M} \qquad ( 30 )$$

$${R}_{n} = \frac{1}{T} {\sum }_{t = 1}^{T} \frac{x ( f , t ) {x ( f , t )}^{h}}{{λ}_{i} ( f , t ) + {λ}_{n} ( f , t )} ∈ {S}_{++}^{M} \qquad ( 31 )$$

Since the optimization problem has the same form as IVE, efficient optimization can be achieved by using a block coordinate descent method (an iterative projection method) of updating parameters in the order of (Wₙ, Ω)→w₁→ . . . →(Wₙ, Ω) W_{K}.

The optimization of the separation filter wᵢ (where i=1, . . . , K) ∈C^{M} of cm is performed as follows.

$$\begin{matrix}[ Math . 12 ] & \\ {w}_{i} ← {( {W}^{h} {R}_{i} )}^{- 1} {e}_{i} & ( 32 )\end{matrix}$$

$${w}_{i} ← \frac{{w}_{i}}{\sqrt{{w}_{i}^{h} {R}_{i} {w}_{i}}} \qquad ( 33 )$$

The problem of minimizing the objective function g for the parameters (Wⁿ, Ω) can be solved as follows.

[Math. 13]

Wₙ∈ [symbol] ^{M×(M-K)} with Wₛ^{h}RₙWₙ=O (34)

Ω=Wₙ^{h}RₙWₙ∈S₊₊^{M-K} (35)

Here, Wₛ=[w₁, . . . , w_{K}] Any selection scheme for Wₙ is used. For example, the following may be selected.

$$\begin{matrix}[ Math . 14 ] & \\ {W}_{n} = [ \begin{matrix}{( {W}_{s}^{h} {R}_{n} {E}_{s} )}^{- 1} ( {W}_{s}^{h} {R}_{n} {E}_{n} ) \\ - {I}_{M - K}\end{matrix} ] & ( 36 )\end{matrix}$$

Here, Eₛ=[e₁, . . . , e_{K}], Eₙ=[e_{K+1}, . . . , e_{M}].

### «Optimization Problem of Parameters (Φ, Ψ)»

When the parameters (W, Ω) are fixed, the problem of minimizing the objective function g with respect to the parameters (Φ, Ψ) is written and expressed as follows.

$$\begin{matrix}[ Math . 15 ] & \\ \begin{matrix}{minimize}_{Φ , Ψ} g ( Φ , Ψ ) ( defined by ( 27 ) ) \\ subject to {λ}_{i} = {Φ}_{i} {Ψ}_{i} ∈ {ℝ}_{\geq 0}^{F \times T} , {Φ}_{i} ∈ {ℝ}_{\geq 0}^{F \times r} , {Ψ}_{i} ∈ {ℝ}_{\geq 0}^{r \times T}\end{matrix} \} & ( 37 )\end{matrix}$$

For this problem, the following updating expression can be obtained by deriving a majorization minimization (MM) algorithm.

$$\begin{matrix}[ Math . 16 ] & \\ {Y}_{i} = {[ {\vert {y}_{i} ( f , t ) \vert}^{2} ]}_{f , t} ∈ {ℝ}_{\geq 0}^{F \times T} & ( 38 )\end{matrix}$$

$${Y}_{n} = [ {\vert {z ( f , t )}^{h} {Ω ( f )}^{- 1} z ( f , t ) \vert}^{2} ] \qquad ( 39 )$$

$${Z}_{i} = {Φ}_{i} {Ψ}_{i} + {Φ}_{n} {Ψ}_{n} , i ∈ \{ 1 , ⋯ , K ] \qquad ( 40 )$$

$${Z}_{n} = {Φ}_{n} {Ψ}_{n} \qquad ( 41 )$$

$${Φ}_{i} ← {Φ}_{i} ⊙ {[ \frac{( {Y}_{i} ⊙ {Z}_{i}^{[ - 2 ]} ) {Ψ}_{i}^{T}}{{Z}_{i}^{[ - 1 ]} {Ψ}_{i}^{T}} ]}^{\frac{1}{2}} \qquad ( 42 )$$

$${Ψ}_{i} ← {Ψ}_{i} ⊙ {[ \frac{{Φ}_{i}^{T} ( {Y}_{i} ⊙ {Z}_{i}^{[ - 2 ]} )}{{Φ}_{i}^{T} {Z}_{i}^{[ - 1 ]}} ]}^{\frac{1}{2}} \qquad ( 43 )$$

$${Φ}_{n} ← {Φ}_{n} ⊙ {[ \frac{( {\sum }_{i = 1}^{K} \frac{{Y}_{i}}{{Z}_{i}^{[ 2 ]}} + \frac{{Y}_{n}}{{Z}_{n}^{[ 2 ]}} ) {Ψ}_{n}}{( {\sum }_{i = 1}^{K} \frac{1}{{Z}_{i}} + \frac{M - K}{{Z}_{n}} ) {Ψ}_{n}} ]}^{\frac{1}{2}} \qquad ( 44 )$$

$${Ψ}_{n} ← {Ψ}_{n} ⊙ {[ \frac{{Φ}_{n}^{T} ( {\sum }_{i = 1}^{K} \frac{{Y}_{i}}{{Z}_{i}^{[ 2 ]}} + \frac{{Y}_{n}}{{Z}_{n}^{[ 2 ]}} )}{{Φ}_{n}^{T} ( {\sum }_{i = 1}^{K} \frac{1}{{Z}_{i}} + \frac{M - K}{{Z}_{n}} )} ]}^{\frac{1}{2}} \qquad ( 45 )$$

Here, for the matrices A and B∈R_{≥0}^{α×β}, the following notation is a product, a quotient, or power for elements of each matrix.

$$\begin{matrix}[ Math . 17 ] & \\ A ⊙ B , \frac{A}{B} , {A}^{[ x ]} & \end{matrix}$$

When A is a scalar, a quotient of each element of the matrix is defined as follows.

$$\begin{matrix}[ Math . 18 ] & \\ \frac{A}{B} = {[ \frac{A}{{B}_{α , β}} ]}_{α , β} & \end{matrix}$$

### EMBODIMENT

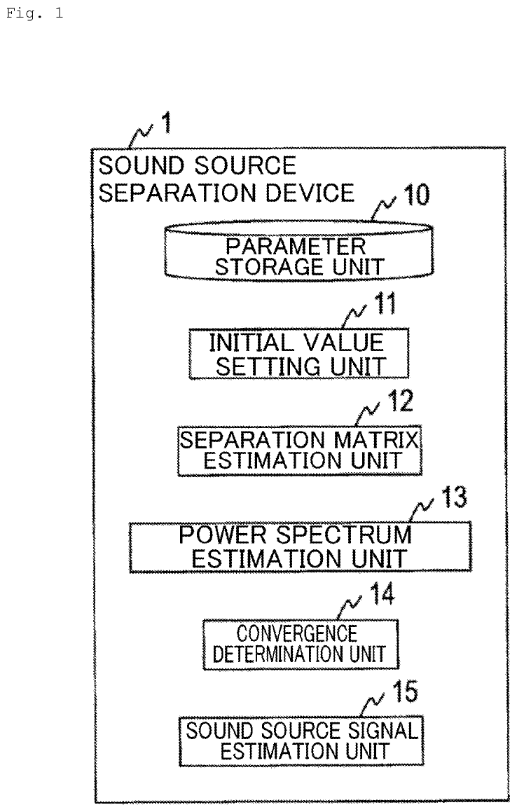

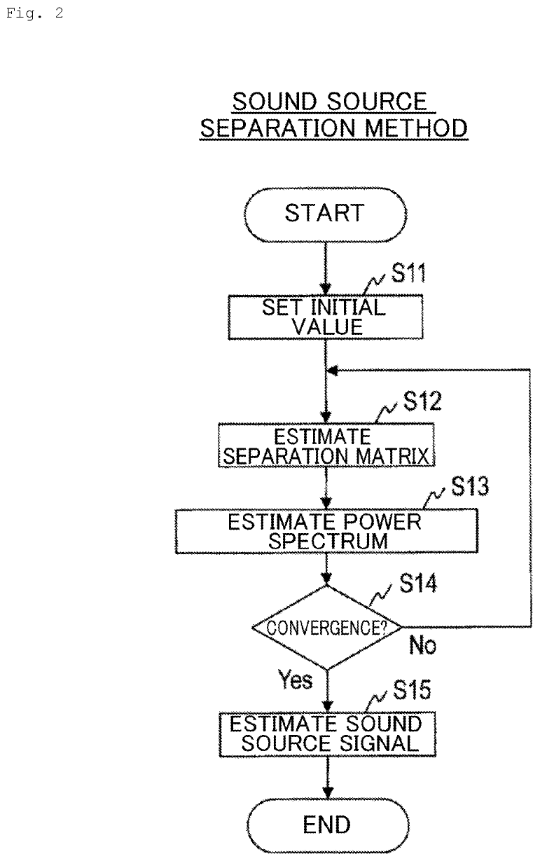

Embodiments of the present invention are a sound source separation device and a sound source separation method of estimating sound source signals s₁, . . . , s_{K} from an observation signal x obtained by collecting a mixed acoustic signal in which K sound source signals s₁, . . . , s_{K} are mixed by a microphone array formed by M microphones. As illustrated in FIG. 1, a sound source separation device 1 according to an embodiment includes a parameter storage unit 10, an initial value setting unit 11, a separation matrix estimation unit 12, a power spectrum estimation unit 13, a convergence determination unit 14, and a sound signal estimation unit 15. The sound source separation method according to an embodiment is implemented by the sound source separation device 1 performing the processing of each step illustrated to FIG. 2.

The sound source separation device 1 is, for example, a specific device that is implemented by a special program read by a known or a dedicated computer that includes a central processing unit (CPU) and a main storage device (a random access memory (RAM)). The sound source separation device 1 executes each processing, for example, under the control of the central processing unit. Data inputted to the sound source separation device 1 and data obtained through each processing are stored in, for example, a main storage device and data stored in the main storage device are read out to the central processing unit, as necessary, to be used for other processing. At least a part of each processing unit of the sound source separation device 1 may be constituted of hardware such as an integrated circuit. Each storage unit of the sound source separation device 1 can be constituted by a main storage device such as a random access memory (RAM), an auxiliary storage device constituted by a semiconductor memory element such as a hard disk, an optical disk or a flash memory, or middleware such as a relational database or a key value store.

Hereinafter, a sound source separation method executed by the sound source separation device 1 according to an embodiment will be described, with reference to FIG. 2.

In a step S11, an initial value setting unit 11 sets appropriate initial values in a separation matrix W(f)=[w₁(f), w_{K}(f), Wₙ(f)], a spatial covariance matrix Ω(f) of the diffusive noise, Φᵢ and Ψᵢ (where i=1, . . . , K) representing a power spectrum of a sound source signal, and Φₙ and Ψₙ representing a power spectrum of diffusive noise. The initial values are stored in the parameter storage unit 10. For example, the initialization is executed to W(f)=IM and Ω(f)=IM−K, each component of Φᵢ and Ψᵢ (where i=1, . . . , K) is initialized using a uniform random number on an interval [0.5, 1], and each component of Φₙ and Ψₙ is initialized using a uniform random number on an interval [0.1, 0, 5].

In a step S12, the separation matrix estimation unit 12 fixes the power spectra Φᵢ, Ψᵢ, Φₙ and Ψₙ, and optimizes the separation matrix W(f) and the spatial covariance matrix Q (f). For example, the optimization can be performed by using the method described in the above-described «Optimization problem of parameters (W, Ω)». The separation matrix estimation unit 12 outputs the optimized parameters (W, Ω) to the power spectrum estimation unit 13.

In step S13, the power spectrum estimation unit 13 fixes the separation matrix W(f) and the spatial covariance matrix Ω(f),and then optimizes the power spectra Φᵢ, Ψᵢ, Φₙ and Ψₙof a target sound source. For example, the optimization can be performed using the scheme described in the above-described <Optimization problem of parameters (Φ, Ψ)». The power spectrum estimation unit 13 outputs the optimized parameters (Φ, Ψ) to the separation matrix estimation unit 12. The optimized parameters (W, Ω, Φ, Ψ) are output to the convergence determination unit 14.

In step S14, the convergence determination unit 14 determines whether a predetermined condition is satisfied. The predetermined condition may be used until a predetermined repetition number is reached or until an update amount of each parameter becomes equal to or less than a predetermined threshold. When the predetermined condition is not satisfied (No), the processing returns to step S12, and the optimization of each parameter is executed again. When the predetermined condition is satisfied (Yes), each parameter stored in the parameter storage unit 10 is updated with the parameters (W, Ω, Φ, Ψ) at that time and the processing proceeds to step S15.

In step S15, the sound signal estimation unit 15 accepts the observation signal x obtained by collecting a mixed acoustic signal in which K sound source signals s₁, . . . , s_{K} are mixed in a microphone array formed by M microphones as an input and estimates K sound source signals s₁, . . . , s_{K} using the parameters (W, Ω, Φ, Ψ) stored in the parameter storage unit 10. The separation matrix W(f) and the spatial covariance matrix Ω(f) of the diffusive noise satisfy the accidental diagonalization constraint shown in Definition 1. That is, the separation matrix W(f) is configured to convert the steering vector aᵢ(f) from each sound source to the microphone into a unit vector eᵢ, and convert the spatial covariance matrix Ω(f) of the diffusive noise into a matrix including a diagonal matrix G(f) of which a size is K sound sources. The sound signal estimation unit 15 sets the estimated sound source signals s₁, . . . , s_{K} as an output of the sound source separation device 1.

### <Experiment Result>

In order to confirm the advantageous effects of the present invention, separation performances of four schemes: (1) FastMNMF, (2) ILRMA, (3) ILRMExt, and (4) NoisyILRMA were compared. (3) ILRMExt is a scheme of modeling a spectrum of the IVE based on a time-varying Gaussian distribution by NMF. More specifically, ILRMExt is a scheme of assuming a noise source as a stationary Gaussian and converting Expression (14) is into sᵢ(f, t)=wᵢ(f)^{h}x(f, t) in the model of NoisyILRMA. Experiment conditions are shown in the following table

TABLE 1

| | |
|---|---|
| Mixed signal | Impulse response (RIR) is superimposed on each |
| | of k = 2 sound signals (point sound sources) and |
| | J = 15 noise signals (point sound sources) and |
| | obtained sound image is added to generate (a |
| | total of 20 samples) |
| SNR | Adjusted to SNR = 5 or 10 [dB] |
| RIR | Collected in rwcp real environment sound acoustic |
| | database, and rir measured in residual change |
| | room such as EIB (RT₆₀ = 310 ms) was used |
| Sound signal | Sound signals (point sound sources) used to |
| | generate mixed signal obtained by coupling |
| | signals of same speaker and setting length of 10 |
| | seconds or more, using sound signal of test set of |
| | TIMIT corpus, were used |
| Noise signal | Noise signal (CAF, ch-1) collected in cafe where |
| | CHiME3 was supplied was cut at random and used |
| | as point sound sources |
| STFT | Window length: 4096 (256 ms, 16 kHz), frameshift: |
| | 1/4 |
| Evaluation | SDR between oracle reference signal and |
| index | separation signal was measured |

The SNR is defined by the following expression in which νₖ^{(s)} is average power of a sound image of a sound source signal and νⱼ⁽ⁿ⁾ is average power of a sound image of a noise signal.

$$\begin{matrix}[ Math . 19 ] & \\ S N R = 10 {log}_{10} \frac{\frac{1}{K} {\sum }_{k = 1}^{K} {υ}_{k}^{( s )}}{{\sum }_{j = 1}^{J} {υ}_{j}^{( n )}} & \end{matrix}$$

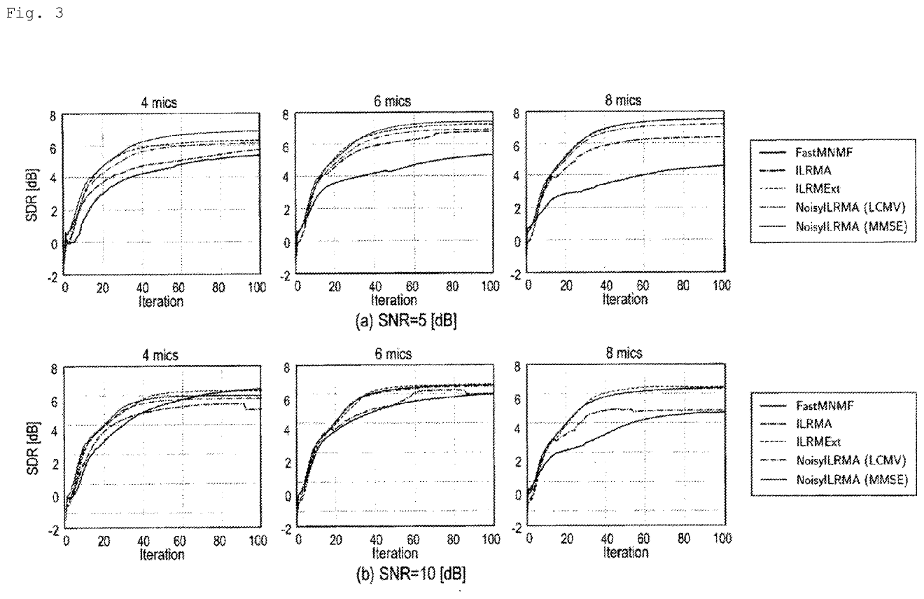

The experimental results are illustrated in FIG. 3. “NoisyILRMA(LCMV)” means that separation by the separation matrix W is executed, and “NoisyILRMA(MMSE)” means that separation by a minimum mean square error (MMSE) estimation amount is performed. In all the schemes, the base number of NMF was set to 2. Compared with ILRMA and FastMNMF of the related art, effectiveness of NoisyILRMA was generally confirmed. The embodiments of the present invention have been described above, but specific configurations are not limited to the embodiments, and it goes without saying that appropriate modifications of design or the like made within a scope of the present invention without departing from the spirit of the present invention are also included in the present invention. The various types of processing described in the embodiments are not limited to being executed chronologically in the described order, and may be executed in parallel or individually either in accordance with the processing capability of a device that executes the processing or as necessary.

### [Program and Recording Medium]

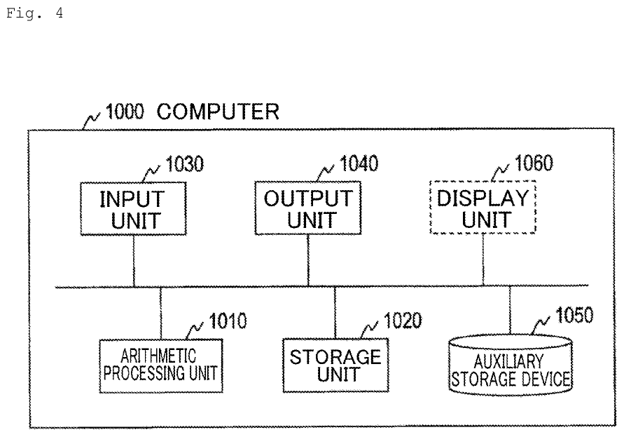

When various processing functions of each device described in the above embodiments are realized by a computer, processing content of the functions that the device should have is described by a program. Then, this program is read to a storage unit 1020 of the computer illustrated in FIG. 4 to cause an arithmetic processing unit 1010, an input unit 1030, an output unit 1040, or the like to execute the program, and thus various types of processing functions in each device are implemented on the computer.

The program describing the processing contents can be recorded on a computer-readable recording medium. The computer-readable recording medium is, for example, a non-transitory recording medium, and is a magnetic recording device, an optical disk, or the like.

The program is distributed, for example, by sales, transfer, or rent of a portable recording medium such as a DVD or a CD-ROM on which the program is recorded. Further, the program may be distributed by storing the program in advance in a storage device of a server computer and transferring the program from the server computer to another computer via a network.

The computer executing such a program first stores, for example, temporarily the program recorded on the portable recording medium or the program transferred from the server computer in an auxiliary recording unit 1050 which is an own non-temporary storage device. When the processing is executed, the computer reads the program stored in the auxiliary recording unit 1050 which is its own non-temporary storage device to the storage unit 1020 which is a transitory storage device, and executes processing in accordance with the read program. As another execution form of the program, the computer may directly read the program from the portable recording medium and execute processing in accordance with the program. Further, whenever the program is transferred from the server computer to the computer, the processing in accordance with the received program may be executed sequentially. According to a so-called application service provider (ASP) type service which does not transfer the program from the server computer to the computer and implements the processing function only in response to the execution instruction and the result acquisition, the above-described processing may be executed. It is assumed that the program in this form includes information or the like to be provided for processing by the electronic computer and equivalent to the program (data or the like which is not a direct command to the computer but has a property defining processing of the computer).

In this form, the device is configured by executing a predetermined program on a computer, but at least some of the processing may be implemented by hardware.

1. A sound source separation device comprising a processor configured to execute operations comprising:
estimating each sound source signal using a separation matrix from an observation signal obtained by collecting a mixed acoustic signal in which a plurality of sound source signals and diffusive noise are mixed by a microphone array formed by a plurality of microphones,
wherein the separation matrix is configured to convert steering vectors from each sound source to the microphone into unit vectors, and convert a spatial covariance matrix of the diffusive noise into a diagonal matrix.

2. The sound source separation device according to claim 1,
wherein K is the number of the sound sources, M is the number of the microphones, f is an index of a frequency bin, i is each integer equal to or greater than 1 and equal to or less than K, W(f) is the separation matrix, aᵢ(f) is a steering vector corresponding to an i-th sound source, eᵢ is a unit vector in which an i-th element is 1 and other elements are 0, V(f) is the spatial covariance matrix, O_{α, β} is a zero matrix of α×β, I_{α} is a unit matrix of α×α, G(f) is a diagonal matrix, and S^{M}₊₊ is the set of all positive-definite Hermitian matrices with a size M, and
wherein the separation matrix satisfies a constraint of the following expression,
$${W ( f )}^{h} {a}_{i} ( f ) = {e}_{í} ∈ {ℂ}^{M}$$
$${W ( f )}^{h} V ( f ) W ( f ) = [ \begin{matrix}G ( f ) & {O}_{K , M - K} \\ {O}_{M - K , K} & {I}_{M - K}\end{matrix} ] ∈ {S}_{+ +}^{M} .$$

3. The sound source separation device according to claim 2,
wherein t is an index of a time frame, wᵢ(f)is a separation filter corresponding to an i-th sound source, Wₙ(f) is a separation filter corresponding to diffusive noise, sᵢ(f, t) is an i-th sound source signal, nᵢ(f, t) is residual noise corresponding to an i-th sound source, x(f, t) is an observation signal, λ₁(f, t), . . . , λ_{M}(f, t) are a power spectrum of each sound source, λₙ(f, t) is a power spectrum of diffusive noise, Ω(f) is the spatial covariance matrix, F is the number of frequency bins, T is the number of time frames, and r is the base number of non-negative matrix factorization, and
wherein the separation matrix is defined in the following expression
W(f)=[w₁(f), . . . , w_{K}(f), Wₙ(f)]wᵢ(f)∈ [symbol] ^{M}, i=1, . . . , K Wₙ(f)∈ [symbol] ^{M×(M-K)}sᵢ(f, t)+nᵢ(f, t)=wᵢ(f)^{h}x(f, t)∈ [symbol] sᵢ(f, t)˜ [symbol] (0, λᵢ(f, t)) nᵢ(f, t)˜ [symbol] (0, λᵢ(f, t)) z(f, t)=Wₙ(f)^{h}x(f, t)∈ [symbol] ^{M-K} z(f, t)˜ [symbol] (0_{M-K}, λₙ(f, t)Ω(f)) λⱼ=ΦⱼΨⱼ∈ [symbol] _{≥0}^{F×T}, j∈{1, . . . , M, n}Φⱼ∈ [symbol] _{≥0}^{F×r}, Ψⱼ∈ [symbol] _{≥0}^{r×T} Ω(f)∈S₊₊^{M-K}

4. A computer implemented method for separating sound sources, comprising:
estimating each sound source signal using a separation matrix from an observation signal obtained by collecting a mixed acoustic signal in which a plurality of sound source signals and diffusive noise are mixed by a microphone array formed by a plurality of microphones,
wherein the separation matrix is configured to convert steering vectors from each sound source to the microphone into unit vectors and convert a spatial covariance matrix of the diffusive noise into a matrix including a diagonal matrix with a size of the number of sound sources.

5. A computer-readable non-transitory recording medium storing computer-executable program instructions that when executed by a processor cause a computer system to execute operations configuring:
estimating each sound source signal using a separation matrix from an observation signal obtained by collecting a mixed acoustic signal in which a plurality of sound source signals and diffusive noise are mixed by a microphone array formed by a plurality of microphones,
wherein the separation matrix is configured to convert steering vectors from each sound source to the microphone into unit vectors and convert a spatial covariance matrix of the diffusive noise into a matrix including a diagonal matrix with a size of the number of sound sources.

6. The computer implemented method according to claim 4,
wherein K is the number of the sound sources, M is the number of the microphones, f is an index of a frequency bin, i is each integer equal to or greater than 1 and equal to or less than K, W(f) is the separation matrix, aᵢ(f) is a steering vector corresponding to an i-th sound source, eᵢ is a unit vector in which an i-th element is 1 and other elements are 0, V(f) is the spatial covariance matrix, O_{α, β} is a zero matrix of α×β, I_{α} is a unit matrix of α×α, G(f) is a diagonal matrix, and S^{M}₊₊ is the set of all positive-definite Hermitian matrices with a size M, and
wherein the separation matrix satisfies a constraint of the following expression,
$${W ( f )}^{h} {a}_{i} ( f ) = {e}_{í} ∈ {ℂ}^{M}$$
$${W ( f )}^{h} V ( f ) W ( f ) = [ \begin{matrix}G ( f ) & {O}_{K , M - K} \\ {O}_{M - K , K} & {I}_{M - K}\end{matrix} ] ∈ {S}_{+ +}^{M} .$$

7. The computer implemented method according to claim 6,
wherein t is an index of a time frame, wᵢ(f) is a separation filter corresponding to an i-th sound source, Wₙ(f) is a separation filter corresponding to diffusive noise, sᵢ(f, t) is an i-th sound source signal, nᵢ(f, t) is residual noise corresponding to an i-th sound source, x(f, t) is an observation signal, λ₁(f, t), . . . , λ_{M}(f, t) are a power spectrum of each sound source, λₙ(f, t) is a power spectrum of diffusive noise, Ω(f) is the spatial covariance matrix, F is the number of frequency bins, T is the number of time frames, and r is the base number of non-negative matrix factorization, and
wherein the separation matrix is defined in the following expression
W(f)=[w₁(f), . . . , w_{K}(f), Wₙ(f)]wᵢ(f)∈ [symbol] ^{M}, i=1, . . . , K Wₙ(f)∈ [symbol] ^{M×(M-K)}sᵢ(f, t)+nᵢ(f, t)=wᵢ(f)^{h}x(f, t)∈ [symbol] sᵢ(f, t)˜ [symbol] (0, λᵢ(f, t)) nᵢ(f, t)˜ [symbol] (0, λᵢ(f, t)) z(f, t)=Wₙ(f)^{h}x(f, t)∈ [symbol] ^{M-K} z(f, t)˜ [symbol] (0_{M-K}, λₙ(f, t)Ω(f)) λⱼ=ΦⱼΨⱼ∈ [symbol] _{≥0}^{F×T}, j∈{1, . . . , M, n}Φⱼ∈ [symbol] _{≥0}^{F×r}, Ψⱼ∈ [symbol] _{≥0}^{r×T} Ω(f)∈S₊₊^{M-K}

8. The computer-readable non-transitory recording medium according to claim 5,
wherein K is the number of the sound sources, M is the number of the microphones, f is an index of a frequency bin, i is each integer equal to or greater than 1 and equal to or less than K, W(f) is the separation matrix, aᵢ(f) is a steering vector corresponding to an i-th sound source, eᵢ is a unit vector in which an i-th element is 1 and other elements are 0, V(f) is the spatial covariance matrix, O_{α, β} is a zero matrix of α×β, I_{α} is a unit matrix of α×α, G(f) is a diagonal matrix, and S^{M}₊₊ is the set of all positive-definite Hermitian matrices with a size M, and
wherein the separation matrix satisfies a constraint of the following expression,
$${W ( f )}^{h} {a}_{í} ( f ) = {e}_{í} ∈ {ℂ}^{M}$$
$${W ( f )}^{h} V ( f ) W ( f ) = [ \begin{matrix}G ( f ) & {O}_{K , M - K} \\ {O}_{M - K , K} & {I}_{M - K}\end{matrix} ] ∈ {S}_{+ +}^{M} .$$

9. The computer-readable non-transitory recording medium according to claim 8,
wherein t is an index of a time frame, wᵢ(f)is a separation filter corresponding to an i-th sound source, Wₙ(f) is a separation filter corresponding to diffusive noise, sᵢ(f, t) is an i-th sound source signal, nᵢ(f, t) is residual noise corresponding to an i-th sound source, x(f, t) is an observation signal, λ₁(f, t), . . . , λ_{M}(f, t) are a power spectrum of each sound source, λₙ(f, t) is a power spectrum of diffusive noise, Ω(f) is the spatial covariance matrix, F is the number of frequency bins, T is the number of time frames, and r is the base number of non-negative matrix factorization, and
wherein the separation matrix is defined in the following expression
W(f)=[w₁(f), . . . , w_{K}(f), Wₙ(f)]wᵢ(f)∈ [symbol] ^{M}, i=1, . . . , K Wₙ(f)∈ [symbol] ^{M×(M-K)}sᵢ(f, t)+nᵢ(f, t)=wᵢ(f)^{h}x(f, t)∈ [symbol] sᵢ(f, t)˜ [symbol] (0, λᵢ(f, t)) nᵢ(f, t)˜ [symbol] (0, λᵢ(f, t)) z(f, t)=Wₙ(f)^{h}x(f, t)∈ [symbol] ^{M-K} z(f, t)˜ [symbol] (0_{M-K}, λₙ(f, t)Ω(f)) λⱼ=ΦⱼΨⱼ∈ [symbol] _{≥0}^{F×T}, j∈{1, . . . , M, n}Φⱼ∈ [symbol] _{≥0}^{F×r}, Ψⱼ∈ [symbol] _{≥0}^{r×T} Ω(f)∈S₊₊^{M-K}
